(19) United States
(12) Patent Application Publication
(10) Pub. No.: US 2018/0046967 A1
(43) Pub. Date: Feb. 15, 2018

(54) FAIRNESS EVALUATION FRAMEWORK FOR INCENTIVE SCHEMES IN A SERVICE-BASED ENVIRONMENT

(71) Applicant: Conduent Business Services, LLC, Dallas, TX (US)

(72) Inventors: Rahul Ghosh, Bangalore (IN); Soumi Chattopadhyay, West Bengal (IN); Ansuman Banerjee, West Bengal (IN); Koustuv Dasgupta, Bangalore (IN); Ashish Garg, Ghaziabad (IN); Vivek Setia, New Delhi (IN)

(21) Appl. No.: 15/232,878

(22) Filed: Aug. 10, 2016

(51) Int. Cl. G06Q 10/06; G06F 17/30

(52) U.S. Cl. CPC G06Q 10/06393; G06F 17/3053

(57) ABSTRACT

Embodiments of a system and a method for evaluating fairness of an incentive scheme are disclosed. The method includes generating desired ranks for a set of employees based on multiple Key Performance Indicator (KPI) vectors associated with the set, where the generated desired ranks are refined based on a most promising vector in the plurality of KPI vectors; computing a distance between a pair of ranks including a pre-set rank based on a predefined incentive scheme and a desired rank from the generated desired ranks for each employee; comparing the computed distance for each employee in the set with a predefined value; evaluating the pre-set rank to be fair and indicative of the predefined incentive scheme being fair to a corresponding employee if the computed distance is relatively less than the predefined value based on the comparison; and displaying a visualization of the computed distance.

### TECHNICAL FIELD

The presently disclosed embodiments relate to incentive management systems, and more particularly, systems and methods for quantitative evaluation of organizational incentive schemes.

### BACKGROUND

Organizations often motivate their employees to deliver high performance while ensuring organizational objectives being met. Employees can be motivated through incentives (e.g., cash, stocks, compensatory time-off, etc.) in addition to several other human resource management (HRM) tools such as trainings, challenging projects, appreciations, and so on. The incentives are typically calculated based on a suitable incentive scheme that reflects the organization wide objectives, for example, maximize productivity, quality, etc.

After an incentive scheme is rolled-out, several non-intuitive outcomes are often observed due to the inherent design of the incentive scheme. For example, a poorly designed incentive scheme can: (a) de-motivate top performers from delivering high volume and high quality of work, (b) allow mid-performers not to push themselves to a higher limit at which they can deliver, and (c) potentially increase the number of low performers, thereby reducing profits for the organization. Such non-intuitive outcomes are undesirable and can hurt business operations. On the other hand, a well-designed incentive scheme is critical for implementing the notion of social wellness, competitive thrust, and a drive towards fair performance. Therefore, it is quintessential to analyze an incentive scheme to evaluate whether or not the intended impact has been achieved.

Conventional approaches focus on behavioral cues (e.g., attrition rate) or organizational performance (e.g., financial gains) to evaluate the impact of an implemented incentive scheme. Such approaches, however, are based on empirical observations that are random and often suffer from individual biasing. Moreover, the evaluated impact is typically relative to another incentive scheme and characteristically lacks the fairness of an incentive scheme being defined with respect to an employee.

Therefore, there exists a need for a systematic, robust, and employee-centric technique that evaluates the fairness of an incentive scheme and provides scientific insights into the impact of scheme parameters.

### SUMMARY

One exemplary embodiment of the present disclosure includes a computer-implemented method for evaluating fairness of an incentive scheme providing a rank-based incentive disbursement to employees in a service-based environment. The method includes receiving, using a data input module on a computer with a processor and a memory, pre-set ranks of a set of employees for incentive disbursement based on a predefined incentive scheme; generating, using a desired rank generator on the computer, desired ranks for the set of employees based on a plurality of key performance indicator (KPI) vectors associated with the set of employees, wherein the generated desired ranks are being refined by the desired rank generator based on a most promising vector in the plurality of KPI vectors; computing, using a comparator on the computer, a distance between a pair of ranks including a pre-set rank from the received pre-set ranks and a desired rank from the generated desired ranks for each employee in the set of employees; comparing, using the comparator, the computed distance for each employee in the set with a predefined value; evaluating, using the comparator, the pre-set rank to be fair and indicative of the predefined incentive scheme being fair to a corresponding employee if the computed distance is relatively less than the predefined value based on the comparison; and displaying, using an output module, a visualization of the computed distance, wherein the visualization is generated by the comparator.

Another exemplary embodiment of the present disclosure includes a system for evaluating fairness of an incentive scheme providing a rank-based incentive disbursement to employees in a service-based environment. The system includes a data input module, a desired rank generator, a comparator, and an output module. The data input module on a computer with a memory and a processor is configured to receive pre-set ranks of a set of employees for incentive disbursement based on a predefined incentive scheme. The desired rank generator on the computer is configured to generate desired ranks for the set of employees based on a plurality of key performance indicator (KPI) vectors associated with the set of employees. The generated desired ranks are refined by the desired rank generator based on a most promising vector in the plurality of KPI vectors. The comparator on the computer is configured to compute a distance between a pair of ranks including a pre-set rank from the received pre-set ranks and a desired rank from the generated desired ranks for each employee in the set of employees, and compare the computed distance for each employee in the set with a predefined value. Further, the comparator evaluates the pre-set rank is fair and indicates that the predefined incentive scheme is fair to a corresponding employee if the computed distance is relatively less than the predefined value based on the comparison. The comparator also generates a visualization of the computed distance for each employee in the set. The output module is configured to display the generated visualization of the computed distance.

Yet another exemplary embodiment of the present disclosure includes a non-transitory computer-readable medium comprising computer-executable instructions for evaluating fairness of an incentive scheme providing a rank-based incentive disbursement to employees in a service-based environment. The non-transitory computer-readable medium includes instructions for receiving pre-set ranks of a set of employees for incentive disbursement based on a predefined incentive scheme; generating desired ranks for the set of employees based on a plurality of key performance indicator (KPI) vectors associated with the set of employees, wherein the generated desired ranks are being refined by the desired rank generator based on a most promising vector in the plurality of KPI vectors; computing a distance between a pair of ranks including a pre-set rank from the received pre-set ranks and a desired rank from the generated desired ranks for each employee in the set of employees; comparing the computed distance for each employee in the set with a predefined value; evaluating the pre-set rank to be fair and indicative of the predefined incentive scheme being fair to a corresponding employee if the computed distance is relatively less than the predefined value based on the comparison; and displaying a visualization of the computed distance.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIGS. 1-4 are schematics of network environments including an exemplary fairness evaluation device for evaluating a predefined incentive scheme, according to various embodiments of the present disclosure.

FIG. 5 is a schematic that illustrates the fairness evaluation device of FIG. 1, according to an embodiment of the present disclosure.

FIG. 6 is an exemplary method for implementing a Pareto Front (PF) generator in communication with the fairness evaluation device of FIG. 1, according to an embodiment of the present disclosure.

FIG. 7 is a table that illustrates exemplary Key Performance Indicator (KPI) values for use by the fairness evaluation device of FIG. 1, according to an embodiment of the present disclosure.

FIG. 8 is an exemplary method for implementing a Pareto Front Refinement (PFR) module in communication with the fairness evaluation device of FIG. 1, according to an embodiment of the present disclosure.

FIG. 9 are exemplary graphs (indicated via 900) that illustrate data being visually represented by the fairness evaluation device of FIG. 1, according to an embodiment of the present disclosure.

FIG. 10 is an exemplary method for implementing the fairness evaluation device of FIG. 1, according to an embodiment of the present disclosure.

### DESCRIPTION

The following detailed description is provided with reference to the figures. Exemplary, and in some cases preferred, embodiments are described to illustrate the disclosure, not to limit its scope, which is defined by the claims. Those of ordinary skill in the art will recognize a number of equivalent variations in the description that follows.

### Non-Limiting Definitions

Definitions of one or more terms that will be used in this disclosure are described below without limitations. For a person skilled in the art, it is understood that the definitions are provided just for the sake of clarity, and are intended to include more examples than just provided below.

A “target incentive” is used in the present disclosure in the context of its broadest definition. The target incentive may refer to a monetary budget predefined by an organization, individual or automated system for an employee. For example, it may be a predefined portion (e.g., a percentage) of the gross salary of the employee.

A “quality of work” is used in the present disclosure in the context of its broadest definition. The quality of work may refer to a measure of accuracy computed by a fraction of error-free work items with respect to a total number of work items.

A “key performance indicator” is used in the present disclosure in the context of its broadest definition. The Key Performance Indicator (KPI) may refer to performance parameters used to measure the performance of employees in an organization. Examples of a KPI may include work duration, quality of work, work complexity, etc.

A “positive KPI” is used in the present disclosure in the context of its broadest definition. The positive KPI may refer to a KPI for which a high value is desirable, for example, work duration.

A “negative KPI” is used in the present disclosure in the context of its broadest definition. The negative KPI may refer to a KPI for which a low value is desirable, for example, number of errors.

A “high performer” is used in the present disclosure in the context of its broadest definition. The high performer may refer to a person or an artificial intelligence (AI) system for whom each associated positive KPI has a value relatively greater than a predefined high KPI threshold and each associated negative KPI has a value relatively less than a predefined low KPI threshold.

A “low performer” is used in the present disclosure in the context of its broadest definition. The low performer may refer to a person or an artificial intelligence (AI) system for whom each associated positive KPI has a value relatively less than the predefined high KPI threshold value and each associated negative KPI has a value relatively greater than the predefined low KPI threshold.

An “employee utility” is used in the present disclosure in the context of its broadest definition. The employee utility may refer to a measure of employee performance based on relative values of KPIs associated with an employee. It may represent a combined effect of positive and negative KPI values of the employee.

A “fairness” (of an incentive scheme) is used in the present disclosure in the context of its broadest definition. The fairness may refer to an incentive disbursement based on the ranking of an employee within a set of employees, each employee being ordered according to the respective employee utility in the set.

A “Pareto-optimal front” in a set of one or more KPI vectors is used in the present disclosure in the context of its broadest definition. The Pareto-optimal front may refer to an ordered set of one or more non-dominated KPI vectors, each being associated with an employee.

A “quality of Pareto-optimal front” is used in the present disclosure in the context of its broadest definition. Such quality may refer to an intended or desired ranking of incentive receivers (e.g., employees in an organization) as a function of parameters that control an incentive scheme. Examples of such parameters may include, but not limited to, KPIs and utility.

A “normalized incentive value” for an employee is used in the present disclosure in the context of its broadest definition. The normalized incentive value for an employee may refer to a ratio of an incentive amount and a target incentive associated with that employee.

### Overview

Embodiments are disclosed in the context of a fairness evaluation framework for incentive schemes in a service-based environment. The embodiments include a fairness evaluation device that quantitatively evaluates the fairness of an existing incentive scheme, where the fairness is defined in terms of fairness to employees. Fairness is quantified based on employee ordering with respect to employee utility, which is captured through values of disparate Key Performance Indicators (KPIs) associated with each employee. The fairness evaluation device employs a multi-objective formulation via Pareto-optimal front generation to capture the impact of one or more parameters that control the existing incentive scheme. Quality of the generated Pareto-optimal front is refined via Pareto-frontier refinement based on business domain-specific constraints. Such refinement generates a desired ranking of the employees in terms of their incentive eligibility. Further, the fairness evaluation device computes a distance between a desired ranking and an existing ranking of each employee to quantify a deviation demonstrated by the existing incentive scheme with respect to a desired or fair incentive scheme being predefined. The fair incentive scheme honors relative rankings of the employees based on their KPI values. Therefore, the fairness evaluation device can identify undesired incentive disbursements that may slip through an existing incentive scheme, thereby allowing to optimize the cost of operation by rewarding high performers and cutting costs on low performers.

### Exemplary Embodiments

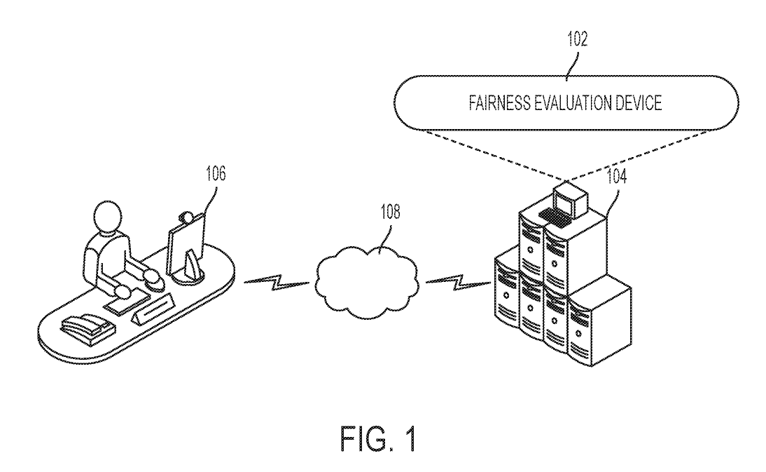

FIGS. 1-4 are schematics of network environments including an exemplary fairness evaluation device 102, according to an embodiment of the present disclosure. Some embodiments are disclosed in the context of a service-based enterprise such as software firms, call centers, etc. However, other embodiments may include or otherwise cover enterprises that provide various on-demand services (e.g., housekeeping services, utility services such as internet services and plumbing services, installation services, etc.), location-based services (e.g., tourist guide services, food services, mobile services, etc.), transport services (e.g., delivery services, moving services, courier services, etc.), marketing/sales services (e.g., content creation services, training services, advertisement services, analytics services, etc.), and so on.

Embodiments may include a fairness evaluation device 102 that interfaces between a server 104 and a user device 106 associated with one or more employees such as an employee in service-based enterprise in different network environments. The user device 106 and the server 104 may be located at a common location (e.g., within the same building) or at different geographical locations. The user device 106 may communicate with the server 104 over a network 108. The network 108 may include any software, hardware, or computer applications that can provide a medium to exchange signals or data in any of the formats known in the art, related art, or developed later. The network 108 may include, but is not limited to, social media platforms implemented as a website, a unified communication application, or a standalone application. Examples of the social media platforms may include, but are not limited to, Twitter™, Facebook™ Skype™, Microsoft Lync™, Cisco Webex™, and Google Hangouts™. Further, the network 108 may include, for example, one or more of the Internet, Wide Area Networks (WANs), Local Area Networks (LANs), analog or digital wired and wireless telephone Networks (e.g., a PSTN, Integrated Services Digital Network (ISDN), a cellular network, and Digital Subscriber Line (xDSL), Wi-Fi, radio, television, cable, satellite, and/or any other delivery or tunneling mechanism for carrying data. The network 108 may include multiple networks or sub-networks, each of which may include, for example, a wired or wireless data pathway. The network 108 may include a circuit-switched voice network, a packet-switched data network, or any other network able to carry electronic communications. For example, the network 108 may include networks based on the Internet protocol (IP) or asynchronous transfer mode (ATM), and may support voice using, for example, VoIP, Voice-over-ATM, or other comparable protocols used for voice, video, and data communications.

The user device 106 may be implemented as any of a variety of computing devices, including, for example, a server, a desktop PC, a notebook, a workstation, a personal digital assistant (PDA), a mainframe computer, a mobile computing device (e.g., a mobile phone, a tablet, etc.), an internet appliance, and so on. The user device 106 may be configured to exchange at least one of text messages, audio interaction data (e.g., voice calls, recorded audio messages, etc.), and video interaction data (e.g., video calls, recorded video messages, etc.) with the server 104, or in any combination thereof. The user device 106 may include calling devices (e.g., a telephone, an internet phone, etc.), texting devices (e.g., a pager), or computing devices including those mentioned above.

In a first exemplary network environment (FIG. 1), the user device 106 may communicate with the server 104 over the network 108. The server 104 may be installed, integrated, or operated with the fairness evaluation device 102 configured to at least one of: (1) communicate synchronously or asynchronously with one or more software applications, databases, storage devices, or appliances operating via same or different communication protocols, formats, database schemas, platforms or any combination thereof, for receiving data; (2) collect, record, and analyze data including KPIs and their values for each employee, one or more existing incentive schemes and their parameters, organizational constraints or objectives, employee incentives, and so on; (3) receive, execute, communicate, formulate, train, or categorize one or more mathematical models to generate desired ranks for a set of employees being associated with a set of KPI vectors; (4) define a fair incentive scheme for each employee based on employee utility; (5) determine a most promising vector from the set of KPI vectors; (6) compute a threshold limit for each KPI; (7) refine desired ranks based on the most promising vector and the threshold limit; (8) compute a distance between a pair of ranks, which include pre-set ranks that are being provided by an incentive scheme and desired ranks being computed for the set of employees; (9) suggest a rank for an employee based on the computed distance being greater than or equal to a predefined value; (10) transfer or map the models, tasks, shared parameters, data or datasets, incentive amounts, predefined KPIs, predefined employee ranks, desired employee ranks, distances between the predefined ranks and the corresponding desired ranks, suggested ranks, a predefined limit for the number of rank changes, or any combination thereof to one or more networked computing devices and/or data repositories.

The fairness evaluation device 102 may represent any of a wide variety of devices capable of providing the fairness evaluation service for an incentive scheme (in terms of fairness to employees) to the network devices. Alternatively, the fairness evaluation device 102 may be implemented as a software application or a device driver. The fairness evaluation device 102 may enhance or increase the functionality and/or capacity of a network, such as the network 108, to which it is connected. In some embodiments, the fairness evaluation device 102 may be also configured, for example, to perform e-mail tasks, security tasks, network management tasks including IP address management, and other tasks. In some other embodiments, the fairness evaluation device 102 may be further configured to expose its computing environment or operating code to a user, and may include related art I/O devices, such as a keyboard or display. The fairness evaluation device 102 of some embodiments may, however, include software, firmware, or other resources that support the remote administration and/or maintenance of the fairness evaluation device 102.

In further embodiments, the fairness evaluation device 102 either in communication with any of the networked devices such as the server 104, or independently, may have video, voice or data communication capabilities (e.g., unified communication capabilities) by being coupled to or including, various imaging devices (e.g., cameras, printers, scanners, medical imaging systems, etc.), various audio devices (e.g., microphones, music players, recorders, audio input devices, speakers, audio output devices, telephones, speaker telephones, etc.), various video devices (e.g., monitors, projectors, displays, televisions, video output devices, video input devices, camcorders, etc.), or any other type of hardware, in any combination thereof. In some embodiments, the fairness evaluation device 102 may comprise or implement one or more real time protocols (e.g., session initiation protocol (SIP), H.261, H.263, H.264, H.323, etc.) and non-real-time protocols known in the art, related art, or developed later to facilitate data transfer between the user device 106, the server 104, the fairness evaluation device 102, and/or any other network device.

In some embodiments, the fairness evaluation device 102 may be configured to convert communications, which may include instructions, queries, data, etc., from the user device 106 into appropriate formats to make these communications compatible with the server 104 and vice versa. Consequently, the fairness evaluation device 102 may allow implementation of the user device 106 or the server 104 using different technologies or by different organizations, for example, a third-party vendor, managing the server 104 or associated services using a proprietary technology.

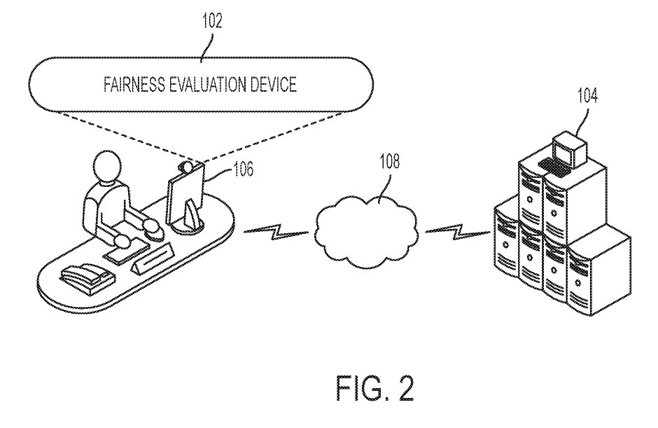

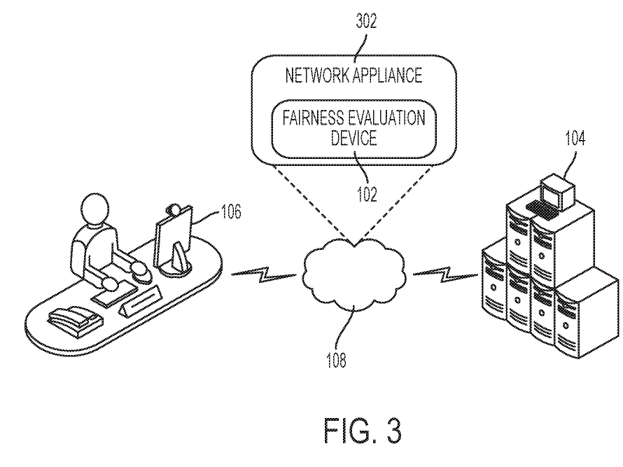

In a second embodiment, the fairness evaluation device 102 may integrate, install, or operate with the user device 106 (FIG. 2) implemented as a single or distributed multiple devices (not shown) that are operatively connected or networked together. In a third embodiment (FIG. 3), the fairness evaluation device 102 may be installed on or integrated with one or more network appliances, such as a network appliance 302 configured to establish the network 108 between the user device 106 and the server 104. At least one of the fairness evaluation device 102 and the network appliance 302 may be capable of operating as or providing an interface to assist the exchange of software instructions and data among the user device 106, the server 104, and the fairness evaluation device 102. In some embodiments, the network appliance 302 may be preconfigured or dynamically configured to include the fairness evaluation device 102 integrated with other devices. For example, the fairness evaluation device 102 may be integrated with the server 104 (as shown in FIG. 1) or any other computing device (not shown) connected to the network 108. The server 104 may include a module (not shown), which enables the server 104 being introduced to the network appliance, thereby enabling the network appliance 302 to invoke the fairness evaluation device 102 as a service. Examples of the network appliance 302 include, but are not limited to, a DSL modem, a wireless access point, a router, a base station, and a gateway having a predetermined computing power and memory capacity sufficient for implementing the fairness evaluation device 102.

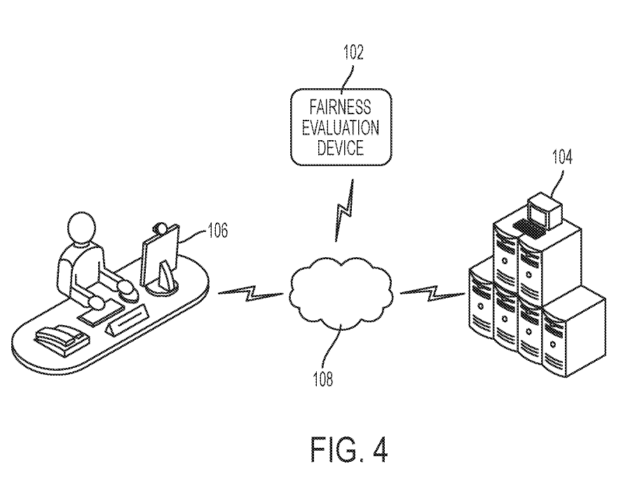

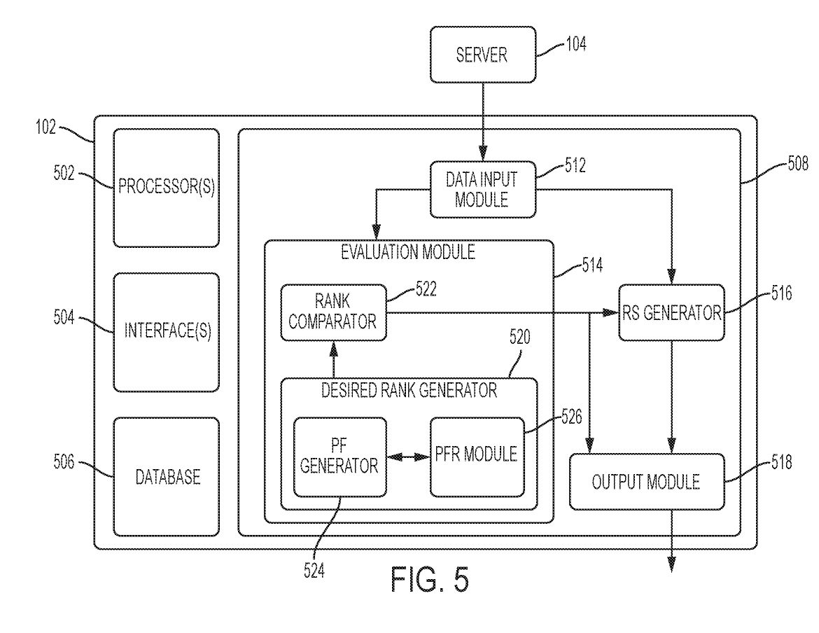

In a fourth embodiment (FIG. 4), the fairness evaluation device 102 may be a standalone device. The fairness evaluation device 102 may include its own processor (shown in FIG. 5) and a transmitter and receiver (TxRx) unit (not shown). In the embodiment of FIG. 4, the user device 106, the server 104, and the fairness evaluation device 102 may be implemented as dedicated devices communicating with each other over the network 108. Accordingly, the fairness evaluation device 102 may communicate directly with the networked devices (e.g., the user device 106, the server 104, etc.) using the TxRx unit.

Further, as illustrated in FIG. 5, the fairness evaluation device 102 may be implemented by way of a single device (e.g., a computing device, a processor or an electronic storage device) or a combination of multiple devices that are operatively connected or networked together. The fairness evaluation device 102 may be implemented in hardware or a suitable combination of hardware and software. In some embodiments, the fairness evaluation device 102 may be a hardware device including processor(s) 502 executing machine readable program instructions to (1) receive, execute, communicate, formulate, train, or categorize one or more mathematical models to generate desired ranks for a set of employees being associated with a set of KPI vectors; (2) define a fair incentive scheme through a desired rank generation for each employee based on employee utility; (3) determine a most promising vector from the set of KPI vectors; (4) compute a threshold limit for each KPI; (5) refine desired ranks based on the most promising vector and the threshold limit; (6) compute a distance between a pair of ranks, which include pre-set ranks that are being provided by an incentive scheme and desired ranks being computed for the set of employees; (7) suggest a rank for an employee based on the computed distance being greater than or equal to a predefined value. The “hardware” may comprise a combination of discrete components, an integrated circuit, an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications or on one or more processors. The processor(s) 502 may include, for example, microprocessors, microcomputers, microcontrollers, digital signal processors, central processing units, state machines, logic circuits, and/or any devices that manipulate signals based on operational instructions. Among other capabilities, the processor(s) 502 may be configured to fetch and execute computer-readable instructions in a system memory 508 associated with the fairness evaluation device 102 for performing tasks such as signal coding, data processing input/output processing, power control, and/or other functions.

In some embodiments, the fairness evaluation device 102 may include, in whole or in part, a software application working alone or in conjunction with one or more hardware resources. Such software application may be executed by the processor(s) 502 on different hardware platforms or emulated in a virtual environment. Aspects of the fairness evaluation device 102 may leverage known, related art, or later developed off-the-shelf software. Other embodiments may comprise the fairness evaluation device 102 being integrated or in communication with a mobile switching center, network gateway system, Internet access node, application server, IMS core, service node, or some other communication systems, including any combination thereof. In some embodiments, the fairness evaluation device 102 may be integrated with or implemented as a wearable device including, but not limited to, a fashion accessory (e.g., a wristband, a ring, etc.), a utility device (a hand-held baton, a pen, an umbrella, a watch, etc.), a body clothing, a safety gear, or any combination thereof.

The fairness evaluation device 102 may also include a variety of known, related art, or later developed interfaces such as interface(s) 504, including software interfaces (e.g., an application programming interface, a graphical user interface, etc.); hardware interfaces (e.g., cable connectors, a keyboard, a card reader, a barcode reader, a biometric scanner, an interactive display screen, a transmitter circuit, a receiver circuit, etc.); or both.

The fairness evaluation device 102 may further include the system memory 508 for storing, at least, one of (1) files and related data including metadata, for example, data size, data format, creation date, associated tags or labels, related videos, images, documents, messages or conversations, KPIs of an employee, etc.; (2) a log of profiles of network devices and associated communications including instructions, queries, conversations, data, and related metadata; and (3) predefined or dynamically defined or calculated mathematical models or equations for incentive scheme evaluation.

The system memory 508 may comprise of any computer-readable medium known in the art, related art, or developed later including, for example, a processor or multiple processors operatively connected together, volatile memory (e.g., RAM), non-volatile memory (e.g., flash, etc.), disk drive, etc., or any combination thereof. The system memory 508 may include one or more databases such as a database 506, which may be sub-divided into further databases for storing electronic files. The system memory 508 may have one of many database schemas known in the art, related art, or developed later for storing the data, predefined or dynamically defined models, and parameter values. For example, the database 506 may have a relational database schema involving a primary key attribute and one or more secondary attributes. In some embodiments, the fairness evaluation device 102 may perform one or more operations including, but not limited to, reading, writing, deleting, indexing, segmenting, labeling, updating, and modifying the data, or a combination thereof, and may communicate the resultant data to various networked computing devices. In one embodiment, the system memory 508 may include various modules such as a data input module 512, an evaluation module 514, a rank suggestion (RS) generator 516, and an output module 518.

### Data Input Module

The data input module 512 may receive a variety of data including employee records and organizational constraints from the user device 106 or the server 104. The employee records may include various details of one or more employees, ε={e₁, e₂, . . . , e₁}. Examples of such details include, but not limited to, employment data (e.g., name, employee ID, designation, tenure, experience, previous organization(s), supervisor name, supervisor employee ID, etc.), demographic data (e.g., gender, race, age, education, accent, income, nationality, ethnicity, area code, zip code, marital status, job status, etc.), psychographic data (e.g., introversion, sociability, aspirations, hobbies, etc.), system access data (e.g., login ID, password, biometric data, etc.), and so on. For each employee e₁, the organization may maintain an individual record including various details related to the employee's performance in past projects.

The organizational constraints may include a variety of KPIs for each employee, where these KPIs may relate to one or more internal and external control objectives. The internal control objectives refer to the reliability of financial reporting, timely feedback on the achievement of operational or strategic goals, and compliance with laws and regulations. For example, the internal control objectives may relate to, without limitation, (1) equipment (e.g., availability details, maintenance cycle, usage training, etc.), (2) people (e.g., technical skills, soft skills, positive or negative behaviors, etc.), (3) policies (e.g., business hours, data access restriction, percentage of business travel, etc.), or any combination thereof. On the other hand, the external control objectives may refer or relate to short-term and long-term implications of decisions made within the organizations on business goals. For example, the external control objectives may relate to, without limitation, (1) resource status (e.g., limited availability of essential inputs (including skilled labor), key raw materials, energy, specialized machinery and equipment, warehouse space, investment funds, etc.), (2) contractual obligations (e.g., labor contracts, product or service licenses, etc.), (3) laws and regulations (e.g., minimum wage, health and safety standards, fuel efficiency requirements, anti-pollution regulations, fair pricing and marketing practices, etc.), or any combination thereof.

Each employee may be associated with a set of disparate KPIs being used to measure employee performance. Each set of disparate KPIs may include combinable and non-combinable KPIs. For example, the non-combinable KPIs may include work duration of an employee and her quality of work. On the other hand, the employee may be involved in different types of work such as filling-up forms, performing a market research, imparting a training, etc. The work duration for each type of work may be combinable in an additive sense, and the total work duration of the employee may be the addition of these individual work durations. Some embodiments in which the importance of each type of work is not equal, such combination may be a weighted sum. Similarly, the non-combinable KPIs may be completely independent or may have some relationship between them with respect to an incentive function. For example, the work duration of an employee may have an indirect impact on the incentive function with respect to the quality of work, since an employee having a significantly long work duration but very low quality of work may not be eligible for high incentives. Such KPIs may constitute non-combinable KPIs that may not be combined to create a single objective or KPI to compute the incentive ordering.

In one embodiment, the data input module 512 may receive key performance indicator (KPI) vectors being representative of a set of employees. Each KPI vector may be associated with an employee and may include values of one or more KPIs being predefined based on the organization constraints. For example, the data input module 512 may receive data being associated with a department of a BPO service business, where the data may include KPIs to measure employee performance. Examples of such KPIs may include, but not limited to, (1) duration of work type-1 (WT1), which may measure the time to process a business transaction (e.g., manual processing of payment); (2) duration of work type-2 (WT2), which may measure the time to audit a processed transaction (e.g., checking the quality of work); (3) duration of work type-3 (WT3), which may measure the time spent in special tasks (e.g., on-boarding a new client) each being unassociated with an estimated time duration for its completion; and (4) quality of work (QW), which may measure the percentage of transactions that may be processed correctly. All durations may be measured in a suitable time unit, e.g., minutes. The dataset may include the employee records in terms of their target incentive and the values of these KPIs.

The data input module 512 may further receive pre-set ranks of employees for incentive distribution based on a predefined incentive scheme. Each pre-set rank of an employee may be associated with an incentive value for which the employee is eligible. The incentive value may be precomputed based on a vector of KPI values and a target incentive, both being associated with the employee. A target incentive for each employee may vary depending on a respective gross salary of the employee. The incentive value of each employee may be normalized for a fair comparison with incentive values of other employees. In one embodiment, the data input module 512 may be configured to compute such normalized incentive value (NIV) for each employee as a ratio of a predetermined incentive amount and a target incentive associated with that employee. Other embodiments may include a predetermined NIV for each employee being received as input by the data input module 512 from the user device 106 or the server 104. The evaluation module 514 may be configured to compute desired ranks for the set of employees for disbursement of incentives and determine deviation of the pre-set ranks from the desired ranks for evaluation of an existing incentive scheme. The evaluation module 514 may include a desired rank generator 520 and a rank comparator 522.

### Desired Rank Generator

The desired rank generator 520 may be preconfigured or dynamically configured to generate desired rankings for the employees. Such desired ranking may be used to provide fairness to employees in the context of incentive disbursement based on a scalar quantity called as employee utility, which may be captured through the disparate KPIs. The employee utility may define the notion of fairness to employees in the context of a rank-based incentive disbursement according to an existing incentive scheme. Therefore, an overall rank order of the employees may be defined based on their respective utility or KPI values. Based on the employee utility, an employee with better KPI values may have a lower rank in an employee rank ordering, where the lower rank may represent more rewards or incentives for the employee while ordering the employees based on disbursable incentives. The specification of the employee utility or a related utility function may be specific to different job domains, for example, human resource, operations, sales and marketing, etc. The utility function may accordingly have properties of strict dominance and majority dominance.

Let u₁ and u₂ be the utilities of employees e₁ and e₂ with KPI vectors [symbol] ₁=(v₁₁, v₁₂, . . . , v₁ₖ) and [symbol] ₂=(v₂₁, v₂₂, . . . , v₂ₖ), respectively. According to the strict dominance property of the utility function, if v₁ᵢ is better than v₂ᵢ for all pᵢε [symbol] , then u₁ has a utility value more than u₂. Similarly, according to the majority dominance property of the utility function, if v₁ᵢ is better than v₂ᵢ for majority (e.g., more than 50%) of pᵢε [symbol] , then u₁ has a utility value more than u₂. The desired rank generator 520 may receive multiple KPI vectors and the pre-set ranks associated with the employees from the data input module 512. The desired rank generator 520 may include a Pareto front (PF) generator 524 and a Pareto front refinement (PFR) module 526 to determine a desired rank for each employee based on KPI values in the associated KPI vector. The desired rank generator 520 may be preconfigured or dynamically configured to consider received values of KPIs as non-combinable for determining a non-dominated KPI vector associated with an employee. However, the KPIs being non-combinable, the desired rank generator 520 may be configured to implement a multi-criteria optimization involving more than one objective (i.e., a KPI such as work duration, quality of work, or work complexity, etc.) to be optimized simultaneously using the Pareto front (PF) generator 524 and the Pareto front refinement (PFR) module 526.

### Pareto Front Generator

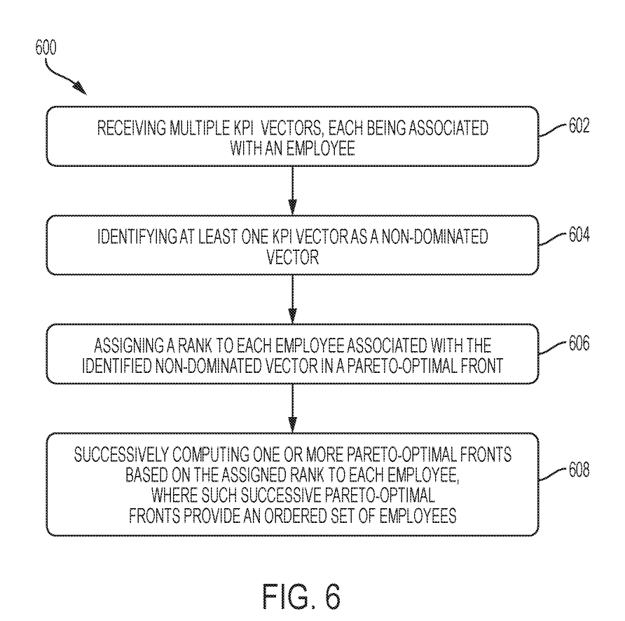

Operation of the PF generator 524, in communication with the desired rank generator 520 and the PFR module 526, is discussed with reference to FIG. 6, which illustrates an exemplary method for implementing the PF generator 524. The exemplary method 600 may be described in the general context of computer-executable instructions. Generally, computer executable instructions may include routines, programs, objects, components, data structures, procedures, modules, functions, and the like that perform particular functions or implement particular abstract data types. The computer executable instructions may be stored on a computer readable medium, and installed or embedded in an appropriate device for execution.

The order in which the method 600 is described is not intended to be construed as a limitation, and any number of the described method blocks may be combined or otherwise performed in any order to implement the method or an alternate method. Additionally, individual blocks may be deleted from the method without departing from the spirit and scope of the present disclosure described herein. Furthermore, the method 600 may be implemented in any suitable hardware, software, firmware, or combination thereof, that exists in the related art or that is later developed.

The method 600 describes, without limitation, implementation of the exemplary PF generator 524. One of skill in the art will understand that the method 600 may be modified appropriately for implementation in various manners without departing from the scope and spirit of the disclosure. The method 600 may be implemented, in at least some embodiments, by the PF generator 524 of the fairness evaluation device 102. For example, the PF generator 524 may be configured using the processor(s) 502 to execute computer instructions to perform operations for obtaining an ordered set of employees.

At step 602, multiple KPI vectors are received from the data input module 512. The PF generator 524 may receive multiple KPI vectors including one or more KPI values from the data input module 512, where each KPI vector may be associated with an employee. Since multiple employees may hold a best value, which may be above a predefined threshold, for one or more KPIs, such employees may be relatively superior or better than others on some KPIs. Such superior employees with better KPI values may be referred to as non-dominated and their associated KPI vectors may be referred to as non-dominated KPI vectors. The superior employees may deserve a higher rank in an incentive ordering among all the employees.

At step 604, at least one KPI vector is identified as a non-dominated vector. In one embodiment, the PF generator 524 may be preconfigured or dynamically configured to identify non-dominated vectors, and in turn identify associated employees, from a received set of KPI vectors in one or more iterations. A set of one or more non-dominant vectors being identified in each iteration may form a Pareto-optimal front. Each non-dominant vector includes a value of at least one KPI being relatively greater than other values of that KPI in the remaining KPI vectors, while values of the remaining set of KPIs in the non-dominated vector are approximately equal to values of these KPIs in the remaining KPI vectors. The PF generator 524 may accordingly identify a KPI vector K₁=(vᵢ₁, vᵢ₂, . . . , vᵢₖ) as a non-dominated vector, if there does not exist any other KPI vector K₂, such that at least one element, i.e., KPI, of K₂ has more value than that KPI has in K₁ without degrading the values for the rest of the elements or KPIs.

In one example of three employees e₁, e₂, and e₃ being associated with two KPIs, namely, work duration and work quality, the employees e₁, e₂, and e₃ may be associated with respective KPI vectors having values of these KPIs as (17650; 99), (16892; 98) and (13621; 100), respectively. Out of these KPI vectors, the PF generator 524 may identify the KPI vectors (17650; 99) and (13621; 100) as being non-dominated vectors, since the former has the largest value of the first element or KPI (i.e., work duration) and the latter has the largest value on the second element or KPI (i.e., work quality). On the other hand, the KPI vector (16892; 98) being associated with the employee e₂ may be dominated by the KPI vector (17650; 99) on both the KPIs. In some embodiments, the PF generator 524 may identify more than one KPI vectors as being equivalent to non-dominant vectors. Such identification may occur based on an absolute difference between a value of each KPI in a first KPI vector and another value of that KPI in a second KPI vector. If a value of the absolute difference is relatively less than or equal to a predefined threshold value, then the PF generator 524 may identify both the first KPI vector and the second KPI vector as being the non-dominant vectors. Values of KPIs in all the KPI vectors associated with the employees may be non-negative. In some embodiments, the PF generator 524 may be configured to convert a negative KPI value into a corresponding non-negative KPI value using any of a variety of techniques known in the art, related art, or developed later.

At step 606, a rank is assigned to each employee associated with the identified non-dominated vector in a Pareto-optimal front. Once a non-dominated vector is identified, the PF generator 524 may assign a rank to an associated employee. For example, the PF generator 524 may assign a rank in ascending order beginning from one, where a lower rank may indicate a higher priority of an employee. In one embodiment, the PF generator 524 may assign the same rank to each KPI vector being identified as a non-dominant vector in a Pareto-optimal front. In each iteration of determining one or more non-dominant vectors, a set of ranked employees being associated with these non-dominated vectors may be identified by the PF generator 524 as a first tier of candidates eligible for the highest rank order in the organization, and in turn, the highest proportion of the incentive.

At step 608, one or more Pareto-optimal fronts are being successively computed based on the assigned rank to each employee, where such successive Pareto-optimal fronts provide an ordered set of employees. In one embodiment, the PF generator 524 may, (1) remove one or more employees being associated with the identified non-dominated vectors from the set of employees, where the non-dominated vectors may form a first Pareto-optimal front, and (2) construct the next Pareto-optimal front with the remaining set of employees. The PF generator 524 may accordingly repeat the steps 602-606 to obtained the next rank order, i.e., a ranked set of one or more non-dominated KPI vectors and correspondingly associated employees until all employees are being successively ranked. The PF generator 524 may accordingly successively rank each employee to provide a cumulative Pareto-optimal front including an ordered set of employees being associated with non-dominated vectors. The employees that are associated with the non-dominated vectors in the same level of iteration or the Pareto-optimal front, may have the same rank in the overall employee rank ordering in the ordered set of employees.

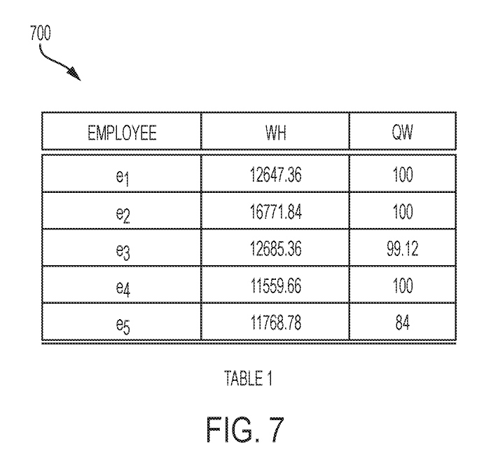

FIG. 7 illustrates a table 700 including values of KPIs, namely, work duration and quality of work, for employees e1, e2, e3, e4, and e5. Based on these exemplary KPI values, the PF generator 524 may obtain a cumulative Pareto-optimal front including an ordered set of employees in multiple iterations. For example, in the first iteration, the PF generator 524 may compute a first Pareto-optimal front that includes the employee e2 as being non-dominated. In the second iteration, a second Pareto-optimal front being computed may include the employees e1 and e3 as being non-dominated. Similarly, in the third iteration, the PF generator 524 may compute a third Pareto-optimal front including KPI vectors, with the corresponding KPI values, being associated with the employees e4 and e5. Accordingly, the PF generator 524 may generate a cumulative Pareto-optimal front with an employee ranking in an order of <e2; 1>; <(e1, e3); 2>; and <(e4, e5); 3>, where <e; r> represents the employee(s) and their corresponding rank(s). The PF generator 524 may communicate the computed cumulative Pareto-optimal front including the ordered set of employees to the PFR module 526.

### Pareto Front Refinement Module

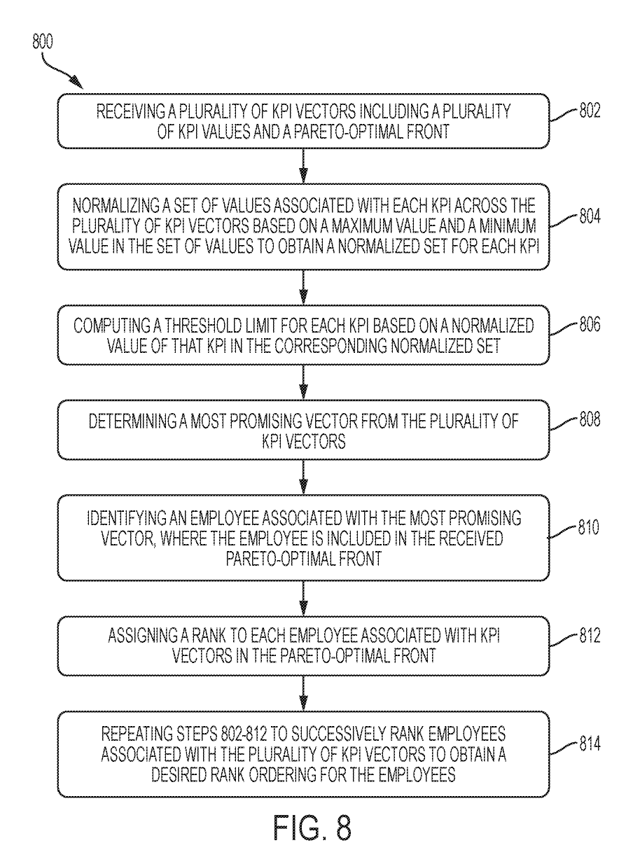

FIG. 8 illustrates an exemplary method for implementing the PFR module 526, according to an embodiment of the present disclosure. The exemplary method 800 may be described in the general context of computer-executable instructions. Generally, computer executable instructions may include routines, programs, objects, components, data structures, procedures, modules, functions, and the like that perform particular functions or implement particular abstract data types. The computer executable instructions may be stored on a computer readable medium, and installed or embedded in an appropriate device for execution.

The order in which the method 800 is described is not intended to be construed as a limitation, and any number of the described method blocks may be combined or otherwise performed in any order to implement the method or an alternate method. Additionally, individual blocks may be deleted from the method without departing from the spirit and scope of the present disclosure described herein. Furthermore, the method 800 may be implemented in any suitable hardware, software, firmware, or combination thereof, that exists in the related art or that is later developed.

The method 800 describes, without limitation, implementation of the exemplary PFR module 526. One of skill in the art will understand that the method 800 may be modified appropriately for implementation in various manners without departing from the scope and spirit of the disclosure. The method 800 may be implemented, in at least some embodiments, by the PFR module 526 of the fairness evaluation device 102. For example, the PFR module 526 may be configured using the processor(s) 502 to execute computer instructions to perform operations for obtaining desired ranks for the employees.

The PFR module 526 may receive the cumulative Pareto-optimal front including the ordered set of employees from the PF generator 524, where the ordered set allows for generation for fair employee rank orderings. The order set may include the associated ranked KPI vectors, each including values of KPIs being treated as non-combinable by the PF generator 524. However, these KPIs may not be considered in isolation or independent of each other while an incentive ordering being created corresponding to the rank orderings. For example, the KPIs such as the work duration and the quality of the work may be dependent on each other despite of being considered as non-combinable or independent. As a result, the PF generator 524 may place an employee in a top tier of ranks if the employee has the highest value of work duration but a lowest value of quality of the work. However, such top tier ranking may be completely undesirable for the employee with lesser than expected high value of the quality of work.

Further as shown in FIG. 7 (Table 1), and discussed above, the PF generator 524 may generate a Pareto-optimal front including employees e4 and e5 in the third iteration. However, if the values of work duration and quality of work are being compared for the employees e4 and e5, the quality of work of e4 may be observed to be much greater than the work quality of e5. On the other hand, the work duration of e4 is not much less than that of e5. Therefore, an ordered set of employees being computed by the PF generator 524 to provide e4 and e5 with the same rank in the incentive ordering may be refined or corrected by the PFR module 526. However, if a Pareto-optimal front in an iteration includes only one KPI vector, then the PFR module 526 may be configured to skip such Pareto-optimal front being refined because that KPI vector may clearly dominate the entire set of KPI vectors among which it is selected.

The PFR module 526 may be preconfigured or dynamically configured to identify a Pareto-optimal front including at least one KPI vector that has an undesirable value for one or more positive or negative KPIs. Such undesirable value of at least one positive KPI may refer to a positive KPI value being below a predefined threshold. Similarly, an undesirable value of at least one negative KPI may refer to a negative KPI value above a predefined threshold. In one embodiment, each type of KPI such as the positive KPI and the negative KPI may have a non-negative value. Accordingly, the PFR module 526 may identify such KPI vector from the cumulative Pareto-optimal front received from the PF generator 524 and reposition it in a final or desired rank ordering of the employees.

At step 802, in one embodiment, a plurality of KPI vectors including a plurality of KPI values and a Pareto-optimal front are received. The PFR module 526 may receive multiple KPI vectors, each being associated with an employee, from the data input module 512 via the PF generator 524. The PFR module 526 may also receive a Pareto-optimal front such as the cumulative Pareto-optimal front including an ordered set of employees being associated with the corresponding non-dominated KPI vectors from the PF generator 524.

At step 804, a set of values associated with each KPI across the plurality of KPI vectors is normalized based on a maximum value and a minimum value in the set of values to obtain a normalized set for each KPI. Since the values of KPIs may come from different contexts and domains, the PFR module 526 may be preconfigured or dynamically configured to normalize a value of each KPI based on Equation 1. Such normalization helps in quantifying the deviation of each KPI within a KPI vector with respect to the best value of KPI in the data set.

$$N\_V ( {v}_{ij} ) = \frac{( {v}_{ij} - {Min}_{pj} )}{( {Max}_{pj} - {Min}_{pj} )} \qquad ( 1 )$$

where,

N_V(vᵤ)=Normalized value of a KPI value vᵢⱼ

Minₚⱼ=Maximum value of a KPI pⱼ across all employees

Maxₚⱼ=Minimum value of a KPI pⱼ across all employees

In some embodiments, the normalized value N_V(vᵢⱼ) of each KPI may be multiplied by a predefined constant for precision. A value of such predefined constant may depend on the size of a dataset including the values of a particular KPI. For example, a dataset may include five values such as 100, 100, 99.12, 100, and 84 for a particular KPI. In this example, the maximum value of the KPI is 100 and the minimum value of the KPI is 84. Accordingly, the KPI values 100, 100, 99.12, 100, and 84 may be normalized to 1, 1, 0.945, 1, and 0 respectively that may be obtained by the PFR module 526 based on Equation 1. Since there are only five values, the constant multiplicative factor may be considered as 1. Such normalized values may collectively form a normalized set for each KPI.

At step 806, a threshold limit for each KPI is computed based on a normalized value of that KPI in the corresponding normalized set. The PFR module 526 may compute a threshold limit for each KPI based on its corresponding computed normalized value. The threshold limit for each KPI may be computed as an average of differences between two consecutive normalized values in a sorted set including the normalized values for each KPI being arranged in a descending order.

At step 808, a most promising vector is determined from the plurality of KPI vectors. In one embodiment, the PFR module 526 may be preconfigured or dynamically configured to determine a most promising vector from the at least one Pareto-optimal front computed by the PF generator 524 at any iteration. For each employee, the PFR module 526 may calculate a deviation of each KPI from its best value, which may be a highest (or maximum) normalized value if that KPI is a positive KPI, or a lowest (or minimum) normalized value if that KPI is a negative KPI. The PFR module 526 may further compute a deviation of each normalized value from the determined best value for each KPI based on Equations 2, 3, and 4.

MinD=MAXⱼ{(MAXᵢ{N_V(vᵢⱼ)}−N_V(v₁ⱼ))} (2)

d=MAXⱼ{(MAXᵢ{N_V(vᵢⱼ)}−N_V(vₓⱼ))} (3)

if d<MinD, then MinD=d for x=2 to n (4)

where,

i=1 to n

vᵢⱼ=KPI values

N_V(vᵤ)=Normalized value of a KPI value vᵢⱼ

d=deviation of a normalized KPI value for j=1 to n

The PFR module 526 may sequentially apply the equations 2, 3, and 4 to provide a list of normalized KPI values sorted in an ascending order based on each normalized value having a maximum computed deviation. The last value in the sorted list is a maximum value that may be used as a representative value for an employee whose associated KPI vector includes a KPI value identified as the representative value. Similarly, the PFR module 526 may successively remove the identified representative value and compute a representative value for each employee in the remaining set of employees. In one embodiment, the PFR module 526 may be configured to identify a KPI vector as the most promising vector based on being associated with a KPI having the minimum representative value among the determined representative values of all the KPIs. In some embodiments, if there exist multiple KPI vectors with the same representative value, the PFR module 526 may be configured to choose a KPI vector that dominates others. If there are multiple non-dominated vectors, the PFR module 526 may choose all KPI vectors with the minimum representative values in the considered set of employees associated with that non-dominated vector set and randomly designate any one KPI vector as the most promising vector.

At step 810, an employee associated with the most promising vector is identified, where the employee is included in the received Pareto-optimal front. The PFR module 526 may select an employee being associated with the most promising vector as the most promising employee having a minimum representative value among all the employees. The minimum representative value has a minimum deviation among other representative values.

At step 812, employees associated with KPI vectors are being assigned a rank in the Pareto-optimal front received from the PF generator 524. Based on the most promising vector, the PFR module 526 may select other KPI vectors from the Pareto-optimal front being received from the PF generator 524 based on a threshold value of each KPI. The PFR module 526 may assign a rank to an employee, which is not being identified as the most promising employee, if its associated KPI vector has a value of at least one KPI being relatively greater than another value of that KPI in the most promising vector, while values of rest of the KPIs in that associated KPI vector are above a corresponding local threshold value, which may be adaptively chosen by the PFR module 526 at each iteration based on the most promising vector. In one embodiment, the threshold value may be equivalent to a difference between an actual KPI value and the determined threshold limit for that KPI.

The PFR module 526 may be configured to avoid any KPI value being less than its associated threshold value for assigning a rank to an employee including that KPI. The threshold values may change in every iteration, and therefore may allow the PFR module 526 to select only those employees for whom each KPI value is above the corresponding threshold value. The employees being associated with KPI vectors that are in the original Pareto-optimal front received from the PF generator 524 but are not considered for a rank position, are stored in a different set X and they may be considered separately afterwards. In the subsequent iterations, these stored KPI vectors may be examined and the ones which satisfy the above threshold criterion may be included in the rank list and removed from the set X. At step 814, the PFR module 526 may be configured to repeat steps 802-812 to successively rank employees associated with the plurality of KPI vectors to obtain desired ranks or desired rank ordering for the employees. Accordingly, the PFR module 526 does not explicitly construct a Pareto-optimal front, rather it chooses the most promising vector for a current rank (or current rank position), where the most promising vector belongs to the Pareto-optimal front of the dataset of KPI values received from the PF generator 524. In some embodiments, the size of the employee set and KPI sets may be polynomial in nature. The computed desired rank ordering may be communicated to the rank comparator 522 by the PFR module 526.

### Rank Comparator

The rank comparator 522 may receive the existing ranking or pre-set rank ordering of employees (R_{E}) from the data input module 512 and the computed desired rank ordering (R_{D}) from the PFR module 526. The pre-set rank ordering may include the pre-set ranks of employees for incentive disbursement based on a predefined incentive scheme. In one embodiment, the rank comparator 522 may be preconfigured or dynamically configured to compare R_{E} with R_{D} in order to see how much the computed R_{D} deviate from R_{E} that is predetermined for an organization. The rank comparator 522 may be configured with any of a variety of metrics known in the art, related art, or developed later to compare R_{E} and R_{D} of the employees. In a first embodiment, the rank comparator 522 may be preconfigured or dynamically configured with a property-based metric. The property-based metric may be defined based on strict dominance and majority dominance in an existing incentive scheme, such that if the utility U₁ of an employee e₁ dominates the utility U₂ of another employee e₂, the incentive of e₁ should be greater than the incentive of e₂. Accordingly, the strict dominance metric may be defined as a strict dominance ratio of the total number of employee pairs eᵢ, eⱼ for which Uᵢ dominates Uⱼ in the strict sense and [symbol] (eᵢ)> [symbol] (eⱼ), to the total number of employee pairs eₖ, eₗ for which Uₖ dominates Uₗ in strict sense, where [symbol] (eᵢ) may denote an incentive value for an employee based on a first incentive scheme and [symbol] (eⱼ) may denote an incentive value for an employee based on a second incentive scheme. On the other hand, the majority dominance metric may be defined as a majority dominance ratio of the total number of employee pairs eᵢ, eⱼ for which Uᵢ dominates Uⱼ in majority sense and [symbol] (eᵢ)≧ [symbol] (eⱼ), to the total number of employee pairs eₖ, eₗ for which Uₖ majority dominates Uₗ. The rank comparator 522 may determine an absolute fairness of an incentive scheme based on a predefined tunable parameter δ_{given}, which may be preconfigured with or dynamically received by the rank comparator 522 from the user device 106 or the server 104. In said embodiment, the rank comparator 522 may determine that the first incentive scheme or the second incentive scheme is fair if the strict dominance ratio or the majority dominance ratio may be relatively greater than the predefined tunable parameter δ_{given}. In some embodiments, the rank comparator 522 may determine that the first incentive scheme or the second incentive scheme is fair if the strict dominance ratio or the majority dominance ratio may be relatively less than the predefined tunable parameter δ_{given}.

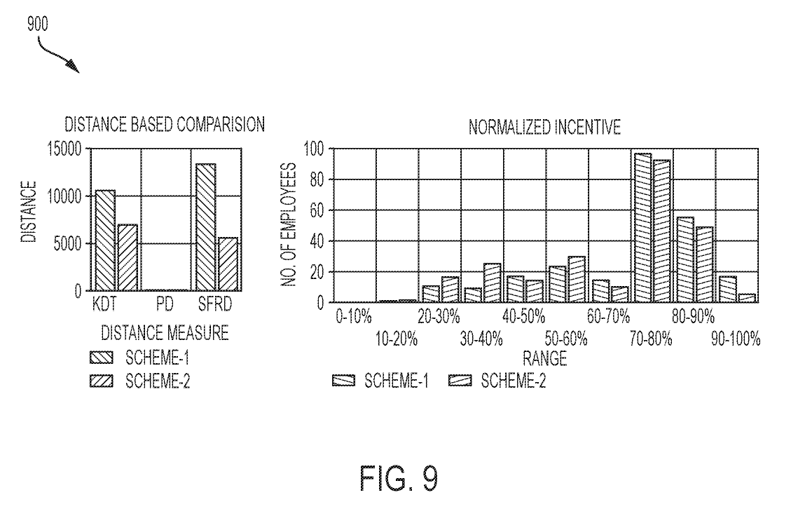

In a second embodiment, the rank comparator 522 may be configured to employ a distance-based metric to compare R_{D} with R_{E}, which may be obtained based on one or more existing incentive schemes. According to the distance-based metric, the rank comparator 522 may measure a distance between a pre-set rank and a computed desired rank of each employee using a distance function based on any of a variety of techniques known in the art, related art, or developed later including, but not limited to, Kendall Tau Distance (KTD), Spearman footrule distance (SFRD), and Percentile distance (PD). Such distance may be measured using one or more pre-set ranks based on different incentive schemes to compute relative fairness of the incentive schemes. In one example, the rank comparator 522 may compute a first distance between a pre-set rank ordering obtained based on a first incentive scheme and the computed desired rank ordering for each employee. Similarly, the rank comparator 522 may compute a second distance between a pre-set rank ordering obtained based on a second incentive scheme and the computed desired rank ordering for each employee. Accordingly, the rank comparator 522 may be preconfigured or dynamically configured to compute a relative fairness of the first incentive scheme and the second incentive scheme based on a comparison between the computed first distance and the second distance. For instance, the rank comparator 522 may determine the first incentive scheme being better than the second incentive scheme, if the first distance is relatively less than the second distance for majority of the employees, for example, more than 50% of the employees, in an employee set. Such distance-based comparison between the pre-set ranks and the computed desired ranks of the employees may be visually represented in a variety of data representation formats known in the art, related art, or developed later including pie charts, histograms, and bar graphs such as shown in FIG. 9. Other parameters such as normalized incentive value for the first incentive scheme, i.e., SCHEME-1, and the second incentive scheme, i.e., SCHEME-2, may also be visually represented such as shown in FIG. 9. In one embodiment, such visualizations may be created by the rank comparator 522 for being sent to and displayed by the output module 518.

In another example, the rank comparator 522 may include or dynamically receive a predefined tunable parameter δ_{given} from the user device 106 or the server 104. Accordingly, the rank comparator 522 may be preconfigured or dynamically configured to determine an absolute fairness of an existing incentive scheme based on the tunable parameter δ_{given}. In one embodiment, the rank comparator 522 may determine that the first incentive scheme is fair if the first distance is relatively less than the tunable parameter δ_{given} for majority of the employees, for example, more than 50% of the employees, in an employee set. On the contrary, the first distance being equal to or relatively greater than δ_{given} may imply that the existing ranking needs to be modified, and hence the first incentive scheme needs improvement. Similar evaluation of the absolute fairness may be performed by the rank comparator 522 for the second incentive scheme. In some embodiments, for different metrics such as the property-based metric and the distance-based metric, the value of δ_{given} may be different. It may be noted that in the desired ranking scheme implemented by the evaluation module 514, more than one KPI vector may have the same rank. Further, the rank comparator 522 may communicate the fairness evaluation result for one or more existing incentive schemes to the output module 518 for being displayed as output. In case an existing incentive scheme is being identified as the one that needs improvement, the pre-set rank ordering of employees based on that existing incentive scheme may be communicated to the RS generator 516 by the rank comparator 522.

### Rank Suggestion Generator

In case the rank comparator 522 identifies the distance between R_{E} and R_{D}, the strict dominance ratio, or the majority dominance ratio being equal to or relatively greater than δ_{given}, the RS generator 516 may be pre-configured or dynamically configured to suggest refinements to the existing ranking scheme. Such refinements may in turn refine the associated incentive scheme by adopting different distance measures and organizational objectives. An organization, in general, may be a bit hesitant in adopting a new incentive scheme, or a new rank ordering. However, small changes in the existing incentive scheme that slowly creep in may be appreciated. A drastic change in the incentive policy may end up harming the performances of the high performers and additionally, it may not be productive to disturb the entire employee population completely. Accordingly, the RS generator 516 may be configured to compute a selective change in the pre-set rank orderings R_{E} based on user definable parameters from the organizational standpoint, and accordingly suggest rank orderings that are in close proximity to both R_{E} and R_{D}. The selective change may be computed to satisfy one or more constraints. One such constraint may include that a subset of employees may not notice any difference in the suggested incentive scheme based on the selective change, and they retain their ranks same as earlier. This is quite intuitive and practical, since any organization may not wish to disturb the high performers in any way, so that they continue to perform better and organizational goals are well met. Another constraint may be based on the fact that an organization, while adopting a new incentive scheme, may only want to affect the performance of a subset of its employees, with an additional constraint that no employee may be pulled apart, more than an allowable limit, from his or her current rank standing. This gives a flexibility to introduce a new incentive scheme slowly and steadily, while affecting a small number of employee population and that too, by a small amount.

The RS generator 516 may receive such constraints and generate rank suggestions accordingly. In one embodiment, for each of these constraints, the RS generator 516 may work on any of the distance measures being computed earlier by the rank comparator 522 for different existing incentive schemes. By mentioning τ number of employees should not be affected by more than α, we mean having the same set of KPIs, τ number of employees can be α rank below in the suggested rank than the existing ranking. If an employee's rank is higher in the suggested rank, the RS generator 516 may not consider them in the τ set of employees. The RS generator 516 may operate on an objective to find a new rank R_{S} which ensures that maximum τ number of employees are affected by not more than α in R_{S} than R_{E}.

In one embodiment, the RS generator 516 may implement an intuitive polynomial-time method for rank suggestion considering a distance function such as KTD or PD. In this method, the RS generator 516 may minimize the number of rank inversions. For employees with R_{E}(Eᵢ)≧R_{D}(Eᵢ), the RS generator 516 may assign their ranks in R_{S} the same as in R_{D}. For the rest of the employees, the RS generator 516 may select at most τ employees and pull the employee ranks down by at most α positions below than their original positions in R_{E}. By doing so, some gaps may be introduced in R_{S}. Finally, the RS generator 516 may shift all the employees up the ranks to fill up the gap.

In another embodiment, the RS generator 516 may implement a polynomial-time method for rank suggestion based on SFRD as the distance function. The method may generate a rank RS based on an objective to reduce the value of |R_{E}(eᵢ)−R_{D}(e₃)| for each employee eᵢ as much as possible. The RS generator 516 may keep the employees eᵢ in the same position in R_{S} if R_{D}(eᵢ) and R_{E}(eᵢ) are equal. If R_{E}(eᵢ)>R_{D}(eᵢ), this means eᵢ has higher rank in R_{E} than in R_{D}.

In said embodiment, the RS generator 516 may create a list L₁ with all such employees and sort them in descending order according to their distances. The RS generator 516 may then retrieve each employee from L₁ and if the employee is not the only one for that rank, the RS generator 516 may push the employee up to the R_{D}(eᵢ)^{th} position in R_{S}. It is to be noted that by doing this, the overall distance between R_{D} and R_{S} reduces than the distance between R_{D} and R_{E}. Similarly, the RS generator 516 may create a list L₂ with all employees such that R_{E}(eᵢ)<R_{D}(eᵢ) and sort them in descending order according to their distances and does a similar thing for at most τ number of employees, but instead of pulling the employees down to the R_{D} (eᵢ)^{th} position in R_{S}, the RS generator 516 may pull them down by at most a distance below. The RS generator 516 may iteratively follow the same strategies until no more changes in R_{S} are possible. With the remaining elements we use swapping strategies. The RS generator 516 may then swap an employee in L₁ with the employee in L₂ only if by swapping them the overall distance between R_{S} and R_{D} reduces. Subsequently, the RS generator 516 may consider the rest of the elements in L₁ and if by pushing an employee from L₁ up, the overall distance between R_{S} and R_{D} reduces, the RS generator 516 may push them up in R_{S}. The ranks of the remaining employees in R_{S} may be assigned as being already present in R_{E} by RS generator 516, which may then communicate the computed new ranks R_{S} of the employees to the output module 518 for being displayed.

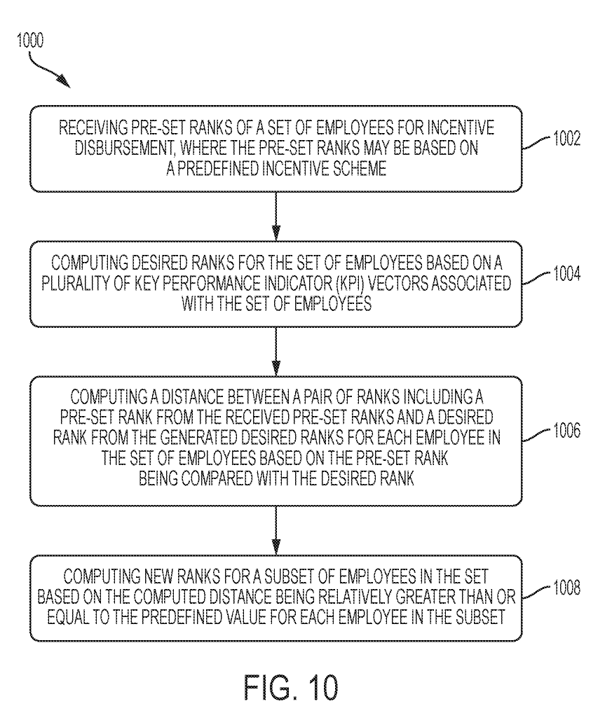

FIG. 10 illustrates an exemplary method of implementing the fairness evaluation device 102, according to an embodiment of the present disclosure. The exemplary method 1000 may be described in the general context of computer-executable instructions. Generally, computer executable instructions may include routines, programs, objects, components, data structures, procedures, modules, functions, and the like that perform particular functions or implement particular abstract data types. The computer executable instructions may be stored on a computer readable medium, and installed or embedded in an appropriate device for execution.

The order in which the method 1000 is described is not intended to be construed as a limitation, and any number of the described method blocks may be combined or otherwise performed in any order to implement the method or an alternate method. Additionally, individual blocks may be deleted from the method without departing from the spirit and scope of the present disclosure described herein. Furthermore, the method 1000 may be implemented in any suitable hardware, software, firmware, or combination thereof, that exists in the related art or that is later developed.

The method 1000 describes, without limitation, implementation of the exemplary PFR module 526. One of skill in the art will understand that the method 1000 may be modified appropriately for implementation in various manners without departing from the scope and spirit of the disclosure. The method 1000 may be implemented, in at least some embodiments, by the PFR module 526 of the fairness evaluation device 102. For example, the PFR module 526 may be configured using the processor(s) 502 to execute computer instructions to perform operations for obtaining desired ranks for the employees.

At step 1002, pre-set ranks of a set of employees for incentive disbursement may be received by the data input module 512, where the pre-set ranks may be based on a predefined incentive scheme. At step 1004, desired ranks for the set of employees may be computed by the desired rank generator 520 based on a plurality of key performance indicator (KPI) vectors associated with the set of employees. The generated desired ranks may be refined by the PFR module 526 based on a most promising vector in the plurality of KPI vectors. At step 1006, a distance between a pair of ranks including a pre-set rank from the received pre-set ranks and a desired rank from the generated desired ranks for each employee in the set of employees may be computed based on the pre-set rank being compared with the desired rank by the rank comparator 522. The pre-set rank may be fair and, therefore, indicate that the predefined incentive scheme is fair if the computed distance is relatively less than a predefined value. At step 1008, new ranks for a subset of employees in the set may be computed by the RS generator 516 based on the computed distance being relatively greater than or equal to the predefined value for each employee in the subset. A number of new ranks being computed or suggested by the RS generator 516 may be based on a predefined limit for rank changes.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the following discussion, numerous references may be made regarding servers, services, engines, modules, interfaces, portals, platforms, or other systems formed from computing devices. It should be appreciated that the use of such terms are deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “generating” or “monitoring” or “displaying” or “tracking” or “identifying” “or receiving” or “comparing” or “evaluating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A computer-implemented method for evaluating fairness of an incentive scheme providing a rank-based incentive disbursement to employees in a service-based environment, the method comprising:
receiving, using a data input module on a computer with a processor and a memory, pre-set ranks of a set of employees for incentive disbursement based on a predefined incentive scheme;
generating, using a desired rank generator on the computer, desired ranks for the set of employees based on a plurality of key performance indicator (KPI) vectors associated with the set of employees, wherein the generated desired ranks are being refined by the desired rank generator based on a most promising vector in the plurality of KPI vectors;
computing, using a comparator on the computer, a distance between a pair of ranks including a pre-set rank from the received pre-set ranks and a desired rank from the generated desired ranks for each employee in the set of employees;
comparing, using the comparator, the computed distance for each employee in the set with a predefined value;
evaluating, using the comparator, the pre-set rank to be fair and indicative of the predefined incentive scheme being fair to a corresponding employee if the computed distance is relatively less than the predefined value based on the comparison; and
displaying, using an output module, a visualization of the computed distance, wherein the visualization is generated by the comparator.

2. The method according to claim 1, wherein the method further comprises:
selecting, using a rank suggestion generator on the computer, a subset of employees from the set based on the comparison, wherein each employee in the subset has an associated computed distance being relatively greater than or equal to the predefined value; and
computing, using the rank suggestion generator, new ranks for one or more employees in the selected subset based on a predefined limit for rank changes.

3. The method according to claim 1, wherein the step of generating desired ranks is being performed in real time and further comprises:
(a) receiving, using a Pareto-front refinement (PFR) module in communication with the desired rank generator on the computer, the plurality of KPI vectors including values of a plurality of KPIs from the data input module;
(b) normalizing, using the PFR module, a set of values associated with each KPI across the plurality of KPI vectors based on a maximum value and a minimum value in the set of values to obtain a normalized set for each KPI;
(c) determining, using the PFR module, a threshold limit for each KPI based on normalized values in the normalized set;
(d) determining, using the PFR module, the most promising vector from the plurality of KPI vectors based on the most promising vector being associated with a KPI having a minimum representative value among the plurality of KPIs across the plurality of KPI vectors;
(e) identifying, using the PFR module, an employee associated with the most promising vector, wherein the identified employee is included in a predefined Pareto-optimal front;
(f) ordering, using the PFR module, another employee associated with each KPI vector in a remaining plurality of KPI vectors into the Pareto-optimal front if that KPI vector includes a value of at least one KPI being relatively greater than another value of the at least one KPI in the most promising vector while values of rest of the KPIs in that KPI vector are above corresponding predefined local threshold values;
(g) assigning, using the PFR module, a predefined rank to the ordered employee;
(h) updating, using the PFR module, the set of employees by removing the ordered employee from the set of employees to obtain an updated set of employees and the predefined rank being incremented by one, wherein the updated set includes an updated plurality of KPI vectors; and
(i) repeating steps (d)-(h), using the PFR module, for the updated set of employees provided at least one employee remains in the updated set to obtain the desired ranks for the set of employees.

4. The method according to claim 3, wherein the step of determining the most promising vector is performed in real time and further comprises:
determining, using the PFR module, a best value in the normalized set for each KPI, wherein the best value is a highest normalized value in the normalized set if that KPI is a positive KPI and a lowest normalized value in the set if that KPI is a negative KPI;
computing, using the PFR module, a deviation of each normalized value from the determined best value in the normalized set;
determining, using the PFR module, in the normalized set, a normalized value as a representative value of each KPI based on the normalized value having a maximum computed deviation; and
identifying, using the PFR module, a KPI vector as the most promising vector based on being associated with a KPI having the minimum representative value among the determined representative value of each KPI in the plurality of KPIs, wherein the most promising vector is associated with a most promising employee in the set of employees.

5. The method according to claim 4, wherein the positive KPI is a KPI for which a high value is desirable and the negative KPI is a KPI for which a low value is desirable.

6. The method according to claim 3, wherein the threshold limit is determined as an average of differences between two consecutive normalized values in a sorted set including the normalized values of the normalized set being arranged in a descending order.

7. The method according to claim 3, wherein each of the local threshold values is equivalent to a difference between a value of a KPI and the determined threshold limit for that KPI.

8. The method according to claim 3, wherein the step of identifying further comprises a method of constructing in real time the predefined Pareto-optimal front including an ordered set of employees, the method comprising:
(i) receiving, using a Pareto-front generator in communication with the desired rank generator on the computer, the plurality of KPI vectors including a first vector and a second vector from the data input module;
(ii) identifying, using the Pareto-front generator, at least one of the first vector and the second vector as a non-dominated vector based on a value of each KPI in the non-dominated vector being relatively greater than another value of that KPI in a remaining plurality of KPI vectors while a first set of values of remaining KPIs in the non-dominated vector are approximately equal to a second set of values of the remaining KPIs in a remaining plurality of KPI vectors;
(iii) assigning, using the Pareto-front generator, a rank to an employee associated with the identified non-dominated vector in the set of employees;
(iv) updating, using the Pareto-front generator, the set of employees by removing the employee associated with the non-dominated vector from the set of employees to provide an updated set of employees; and
(v) repeating steps (ii)-(iv), using the Pareto-front generator, for the updated set of employees provided at least one employee remains in the updated set of employees to obtain the ordered set of employees forming the Pareto-optimal front.

9. The method according to claim 8, wherein the step of identifying at least one of the first vector and the second vector further comprises identifying, using the Pareto-front generator, both the first vector and the second vector as non-dominated vectors if an absolute difference between the value of each KPI and the another value of that KPI is less than or equal to a predefined threshold value.

10. The method according to claim 9, wherein a first employee associated with the first vector and a second employee associated with the second vector are assigned the same rank based on both the first vector and the second vector being identified as the equivalent non-dominated vectors.

11. The method according to claim 9, wherein the value, the another value, the first set of values, and the second set of values are non-negative.

12. A system for evaluating fairness of an incentive scheme providing a rank-based incentive disbursement to employees in a service-based environment, the system comprising:
a data input module on a computer with a memory and a processor being configured to receive pre-set ranks of a set of employees for incentive disbursement based on a predefined incentive scheme;
a desired rank generator on the computer configured to generate desired ranks for the set of employees based on a plurality of key performance indicator (KPI) vectors associated with the set of employees, wherein the generated desired ranks are refined by the desired rank generator based on a most promising vector in the plurality of KPI vectors;
a comparator on the computer configured to:
compute a distance between a pair of ranks including a pre-set rank from the received pre-set ranks and a desired rank from the generated desired ranks for each employee in the set of employees;
compare the computed distance for each employee in the set with a predefined value;
evaluate the pre-set rank to be fair and indicative of the predefined incentive scheme being fair to a corresponding employee if the computed distance is relatively less than the predefined value based on the comparison;
generate a visualization of the computed distance for each employee in the set; and
an output module on the computer configured to display the generated visualization of the computed distance.

13. The system according to claim 12, wherein the system further comprises a rank suggestion generator on the computer configured to:
select a subset of employees from the set based on the comparison, wherein each employee in the subset has an associated computed distance being relatively greater than or equal to the predefined value; and
compute new ranks for one or more employees in the selected subset based on a predefined limit for rank changes.

14. The system according to claim 12, wherein the desired rank generator communicates with a Pareto-front refinement module (PFR module) on the computer being configured to:
(a) receive the plurality of KPI vectors including values of a plurality of KPIs from the data input module via the desired rank generator;
(b) normalize a set of values associated with each KPI across the plurality of KPI vectors based on a maximum value and a minimum value in the set of values to obtain a normalized set for each KPI;
(c) determine a threshold limit for each KPI based on normalized values in the normalized set;
(d) determine the most promising vector from the plurality of KPI vectors based on the most promising vector being associated with a KPI having a minimum representative value among the plurality of KPIs across the plurality of KPI vectors;
(e) identify an employee associated with the most promising vector, wherein the identified employee is included in a predefined Pareto-optimal front;
(f) order another employee associated with each KPI vector in a remaining plurality of KPI vectors into the Pareto-optimal front if that KPI vector includes a value of at least one KPI being relatively greater than another value of the at least one KPI in the most promising vector while values of rest of the KPIs in that KPI vector are above corresponding predefined local threshold values;
(g) assign a predefined rank to the ordered employee;
(h) update the set of employees by removing the ordered employee from the set of employees to obtain an updated set of employees and the predefined rank being incremented by one, wherein the updated set includes an updated plurality of KPI vectors; and
(i) repeat steps (d)-(h) for the updated set of employees provided at least one employee remains in the updated set to obtain the desired ranks for the set of employees.

15. The system according to claim 14, wherein the PFR module determines the most promising vector in real time based on being configured to:
determine a best value in the normalized set for each KPI, wherein the best value is a highest normalized value in the normalized set if that KPI is a positive KPI and a lowest normalized value in the set if that KPI is a negative KPI;
compute a deviation of each normalized value from the determined best value in the normalized set;
determine in the normalized set, a normalized value as a representative value of each KPI based on the normalized value having a maximum computed deviation; and
identify a KPI vector as the most promising vector based on being associated with a KPI having the minimum representative value among the determined representative value of each KPI in the plurality of KPIs, wherein the most promising vector is associated with a most promising employee in the set of employees.

16. The system according to claim 15, wherein the positive KPI is a KPI for which a high value is desirable and the negative KPI is a KPI for which a low value is desirable.

17. The system according to claim 14, wherein the threshold limit is determined as an average of differences between two consecutive normalized values in a sorted set including the normalized values of the normalized set being arranged in a descending order.

18. The system according to claim 14, wherein each of the local threshold values is equivalent to a difference between a value of a KPI and the determined threshold limit for that KPI.

19. The system according to claim 14, wherein the PFR module communicates with a Pareto-front generator on the computer to construct in real time the predefined Pareto-optimal front including an ordered set of employees, the Pareto-front generator being configured to:
(i) receive the plurality of KPI vectors including a first vector and a second vector from the data input module via the desired rank generator;
(ii) identify at least one of the first vector and the second vector as a non-dominated vector based on a value of each KPI in the non-dominated vector being relatively greater than another value of that KPI in a remaining plurality of KPI vectors while a first set of values of remaining KPIs in the non-dominated vector are approximately equal to a second set of values of the remaining KPIs in a remaining plurality of KPI vectors;
(iii) assign a rank to an employee associated with the identified non-dominated vector in the set of employees;
(iv) update the set of employees by removing the employee associated with the non-dominated vector from the set of employees to provide an updated set of employees; and
(v) repeat steps (ii)-(iv) for the updated set of employees provided at least one employee remains in the updated set of employees to obtain the ordered set of employees forming the Pareto-optimal front.

20. The system according to claim 19, wherein the Pareto-front generator is further configured to identify both the first vector and the second vector as non-dominated vectors if an absolute difference between the value of each KPI and the another value of that KPI is less than or equal to a predefined threshold value.

21. The system according to claim 20, wherein a first employee associated with the first vector and a second employee associated with the second vector are assigned the same rank based on both the first vector and the second vector being identified as the non-dominated vectors.

22. The system according to claim 20, wherein the value, the another value, the first set of values, and the second set of values are non-negative.

23. A non-transitory computer-readable medium comprising computer-executable instructions for evaluating fairness of an incentive scheme providing a rank-based incentive disbursement to employees in a service-based environment, the non-transitory computer-readable medium comprising instructions for:
receiving pre-set ranks of a set of employees for incentive disbursement based on a predefined incentive scheme;
generating desired ranks for the set of employees based on a plurality of key performance indicator (KPI) vectors associated with the set of employees, wherein the generated desired ranks are being refined by the desired rank generator based on a most promising vector in the plurality of KPI vectors;
computing a distance between a pair of ranks including a pre-set rank from the received pre-set ranks and a desired rank from the generated desired ranks for each employee in the set of employees;
comparing the computed distance for each employee in the set with a predefined value;
evaluating the pre-set rank to be fair and indicative of the predefined incentive scheme being fair to a corresponding employee if the computed distance is relatively less than the predefined value based on the comparison; and
displaying a visualization of the computed distance.

24. The non-transitory computer-readable medium according to claim 23 further comprises instructions for:
selecting a subset of employees from the set based on the comparison, wherein each employee in the subset has an associated computed distance being relatively greater than or equal to the predefined value; and
computing new ranks for one or more employees in the selected subset based on a predefined limit for rank changes.

25. The non-transitory computer-readable medium according to claim 23, wherein generating desired ranks is being performed in real time and further comprises instructions for:
(a) receiving the plurality of KPI vectors including values of a plurality of KPIs from the data input module via the desired rank generator;
(b) normalizing a set of values associated with each KPI across the plurality of KPI vectors based on a maximum value and a minimum value in the set of values to obtain a normalized set for each KPI;
(c) determining a threshold limit for each KPI based on normalized values in the normalized set;
(d) determining the most promising vector from the plurality of KPI vectors based on the most promising vector being associated with a KPI having a minimum representative value among the plurality of KPIs across the plurality of KPI vectors;
(e) identifying an employee associated with the most promising vector, wherein the identified employee is included in a predefined Pareto-optimal front;
(f) ordering another employee associated with each KPI vector in a remaining plurality of KPI vectors into the Pareto-optimal front if that KPI vector includes a value of at least one KPI being relatively greater than another value of the at least one KPI in the most promising vector while values of rest of the KPIs in that KPI vector are above corresponding predefined local threshold values;
(g) assigning a predefined rank to the ordered employee;
(h) updating the set of employees by removing the ordered employee from the set of employees to obtain an updated set of employees and the predefined rank being incremented by one, wherein the updated set includes an updated plurality of KPI vectors; and
(i) repeating steps (d)-(h) for the updated set of employees provided at least one employee remains in the updated set to obtain the desired ranks for the set of employees.

26. The non-transitory computer-readable medium according to claim 25, wherein determining the most promising vector is being performed in real time and further comprises instructions for:
determining a best value in the normalized set for each KPI, wherein the best value is a highest normalized value in the normalized set if that KPI is a positive KPI and a lowest normalized value in the set if that KPI is a negative KPI;
computing a deviation of each normalized value from the determined best value in the normalized set;
determining in the normalized set, a normalized value as a representative value of each KPI based on the normalized value having a maximum computed deviation; and
identifying a KPI vector as the most promising vector based on being associated with a KPI having the minimum representative value among the determined representative value of each KPI in the plurality of KPIs, wherein the most promising vector is associated with a most promising employee in the set of employees.

27. The non-transitory computer-readable medium according to claim 26, wherein the positive KPI is a KPI for which a high value is desirable and the negative KPI is a KPI for which a low value is desirable.

28. The non-transitory computer-readable medium according to claim 25, wherein the threshold limit is determined an average of differences between two consecutive normalized values in a sorted set including the normalized values of the normalized set being arranged in a descending order.

29. The non-transitory computer-readable medium according to claim 25, wherein each of the local threshold values is equivalent to a difference between a value of a KPI and the determined threshold limit for that KPI.

30. The non-transitory computer-readable medium according to claim 25, wherein identifying further comprises instructions for constructing in real time the predefined Pareto-optimal front including an ordered set of employees, the non-transitory computer-readable medium further comprises instructions for:
(i) receiving the plurality of KPI vectors including a first vector and a second vector from the data input module via the desired rank generator;
(ii) identifying at least one of the first vector and the second vector as a non-dominated vector based on a value of each KPI in the non-dominated vector being relatively greater than another value of that KPI in a remaining plurality of KPI vectors while a first set of values of remaining KPIs in the non-dominated vector are approximately equal to a second set of values of the remaining KPIs in a remaining plurality of KPI vectors;
(iii) assigning a rank to an employee associated with the identified non-dominated vector in the set of employees;
(iv) updating the set of employees by removing the employee associated with the non-dominated vector from the set of employees to provide an updated set of employees; and
(v) repeating steps (ii)-(iv) for the updated set of employees provided at least one employee remains in the updated set of employees to obtain the ordered set of employees forming the Pareto-optimal front.

31. The non-transitory computer-readable medium according to claim 30, wherein identifying at least one of the first vector and the second vector further comprises instructions for identifying both the first vector and the second vector as non-dominated vectors if an absolute difference between the value of each KPI and the another value of that KPI is less than or equal to a predefined threshold value.

32. The non-transitory computer-readable medium according to claim 31, wherein a first employee associated with the first vector and a second employee associated with the second vector are assigned the same rank based on both the first vector and the second vector being identified as the non-dominated vectors.

33. The non-transitory computer-readable medium according to claim 33, wherein the value, the another value, the first set of values, and the second set of values are non-negative.
